(19) United States
(12) Patent Application Publication
(10) Pub. No.: US 2003/0075625 A1
(43) Pub. Date: Apr. 24, 2003

(54) Apparatus and method for comminuting materials

(76) Inventor: Lynn Tessier, Cochrane (CA)

Correspondence Address: GRAYBEAL, JACKSON, HALEY LLP, 155 - 108TH AVENUE NE, SUITE 350, BELLEVUE, WA, 98004-5901, US

(21) Appl. No.: 10/042,052

(22) Filed: Oct. 18, 2001

(51) Int. Cl. B02C 19/06

(52) U.S. Cl. 241/5; 241/39

(57) ABSTRACT

The present invention pertains to an apparatus and method for comminuting source material by fluidizing said source material in a gaseous stream and thereafter projecting said source material against a plurality of impact surfaces contained in, along, or about the periphery of a rotating rigid rotor.

### BACKGROUND OF THE INVENTION

1. Field of the Invention

The present invention lies in the field of particle reduction. More particularly, but not by way of limitation, the present invention pertains to an apparatus and method for comminuting source material by fluidizing said source material in a gaseous stream and thereafter projecting said source material against a plurality of impact surfaces contained in, along, or about the periphery of a rotating rigid rotor.

2. Description of the Prior Art

In the present invention, the words “source material” shall mean any particulate material that is to be comminuted, and the words “comminuted material” shall mean such source material that has been comminuted using the present invention.

Methods for comminuting source material particles are well known within the art and typically utilize a variant of sequential or continuous concussive impacts between the source material and a grinding aid to effect comminution of the source material.

Examples of such sequential or continuous concussive impact technology using wet grinding are ball mills and colloid mills. Typically, the source material (be it a primary ore, mineral, clinker, reclaimed tailings, etc.), after preliminary size reduction by conventional means known within the art, and a grinding media are slurried in a liquid suspending medium and then introduced into the grinding chamber of the mill. Inside, an axial impeller, with or without the assistance of a stator, is rotated to allow the particles of source material to impact with each other and with the grinding media, thus fracturing the source material into smaller particles. In such mills, it is desirable to separate the uncomminuted source material and the grinding media from the comminuted material at the mill outlet so as to retain useful grinding media and uncomminuted source material in the mill while permitting the spent grinding media and the comminuted material and to exit the mill.

Such wet grinding technology is slow (a low rate of throughput), laborious, capital intensive, and energy inefficient. Generally wet grinding mills employ liquid suspending mediums and much of the energy supplied to the mill is dissipated as heat into the liquid or is lost through friction between its constituent elements and is therefore not available for comminution.

The process of dry grinding is practiced today using stirred mills and the multitude of variants thereof, hammer mills, and roller mills outfitted with internal classifiers which elutriate the desired comminuted material and return the uncomminuted source material to the grinding chamber. Such mills use excessive energy, exhibit very high wear, and are inefficient at fine grinding: comminuted particles attach themselves electrostatically to the larger particles of source material which cushion them from impacts during subsequent collisions and thus decrease the efficiency of comminution.

Fluid energy mills for the fine grinding are well known within the art and are used for comminution of, inter alia, pharmaceuticals, foodstuffs, fillers, and toners. A typical fluid energy mill is comprised of a disk-shaped chamber enclosed by two generally parallel circular plates defining axial walls and an annular rim defining a peripheral wall. The axial length or height of the chamber is generally substantially less than the diameter of the chamber.

The source material is fluidized, generally within a gaseous stream, and thereafter projected tangentially to the periphery of a circle smaller than the chamber's periphery through a nozzle or a plurality of nozzles located along the chamber's periphery. Within the chamber, the fluidized source material impacts against one or more impact surfaces or another stream of source material projected through one or more further nozzles. Impact surfaces are oriented transverse to the direction of fluid flow and can be of various compositions and shapes, including plates of various shapes, anvils, baskets of steel balls, stationary rods, etc. The fluidized source material may be removed through an outlet along the axis of the chamber, and comminuted material may be discharged to a cyclone or filter for collection.

Although fluid energy mills allow for any of autogenous, semi-autogenous, or exogenous grinding, they are limited in the materials they are able to comminute and the range of particle sizes produced.

### SUMMARY OF THE INVENTION

The principal object of the present invention is to eliminate the disadvantages of the prior art technologies and to provide an apparatus and method for the dry grinding of source material which yields the desired comminuted material in a safe, energy efficient, environmentally friendly, and regulatory compliant manner, with low capital and operating costs.

In the herein to be described preferred embodiment of the method of the present invention, particles of source material are entrained within and conveyed by a pressurized carrier gas towards a defined grinding point whereat said particles of source material collide with a plurality of impact targets located on or about a rotating rotor as such impact targets pass through said grinding point.

Thus, in the aforesaid preferred embodiment, the present invention may be classified as a jet-mill or a fluid energy mill; for a carrier gas acts as the working fluid and provides energy to accelerate the source material to and against a series of targets for comminution. However, and in contrast with extant jet-mill or fluid energy mill technology, the energy for comminution in the present invention is not derived solely from high external pressure imparting initial velocity onto the particles of source material; it is also derived by way of transfer of the kinetic energy contained within a rigid rotor rotated at speeds in the range of 1,000 to 25,000 revolutions per minute. Thus a limitation of the extant technology, that the initial velocity and the corresponding energy load dissipate over a relatively short distance therefore creating substantial inefficiency is overcome, for additional energy can be introduced into the system efficiently and inexpensively by means of the kinetic energy contained with the rotating rotor; thereby greatly reducing capital costs, operating costs (as the primary operating cost of jet mills is for the power used to drive the compressors that supply the pressurized gas), energy requirements, and maintenance, while allowing for scale-up in capacity.

Moreover, as the particulate source material entrained within the high pressure carrier gas is aimed at and conveyed to the grinding point (whereat distortion energy in excess of the internal strength of the particle of source material is transferred and comminution occurs), direct impact of particles on the internal moving parts of the present invention are avoided as are the commensurate losses due to higher energy consumption and excessive wear and maintenance in extant impact mills.

The above explains the grinding efficiency, low energy requirements, low wear, and low maintenance costs of the present invention.

### DESCRIPTION OF THE PREFERRED EMBODIMENTS

### BRIEF DESCRIPTION OF THE DRAWINGS FOR THE COMMINUTION DEVICE

While the present invention is capable of embodiment in many different forms, there is shown in the drawings and will be described herein in detail a specific embodiment thereof with the understanding that the present disclosure is to be considered as an exemplification of the principles of the invention and is not intended to limit the invention to the specific embodiment or purpose illustrated. The present invention may be embodied in other specific forms and for other purposes and uses without departing from its spirit or essential characteristics.

In these drawings, like reference numerals and reference characters have the same significance.

FIGS. 1a and 1b are, respectively, a top view and a side view of the novel rotating rotor of the present invention;

FIG. 2 is an enlarged detail view of several notches along the periphery of said rotor;

FIGS. 3a, 3b, and 3c are various views illustrating how said rotor is placed on the shaft of the present invention;

FIG. 4 is a cross-sectional view of the grinding chamber of the present invention;

FIG. 5 is an enlarged detail illustration of the grinding point of the present invention;

FIG. 6 is an illustration of the principle of the present invention.

### DETAILED DESCRIPTION OF THE INVENTION

Generally, and as an overview, the present invention is an apparatus and method for comminuting source material by projecting particles of such source material against a plurality of impact targets located along the periphery (3) of, or located within notches (2) along said periphery (3) of, or attached to said periphery (3) of, a rigid rotor (1) revolving at speeds in the range of 1,000 to 25,000 revolutions per minute.

In embodiments, the present invention comprises: said rotor (1); a grinding chamber (14) having a peripheral wall, a base, nozzle aperture (18), and an exit aperture (19); and a nozzle (17) through which a pressurized carrier gas and the source material entrained therein are introduced into said grinding chamber (14). Said nozzle (17) is mounted upon the peripheral wall of said grinding chamber (14) and is oriented to convey the pressurized carrier gas and the source material entrained therein to the grinding point (16)—the point within said grinding chamber (14) whereat the projected particulate source material collides with said rotor's (1) plurality of impact targets when said rotor (1) is rotating.

In variants of the aforementioned embodiments, the present invention comprises: one or a plurality of said rotors (1); one or a plurality of said grinding chambers (14); and one or a plurality of said nozzles (17) through which a pressurized carrier gas and the source material entrained therein are introduced into said grinding chamber (14) or grinding chambers (14). Said plurality of nozzles (17) are mounted upon the peripheral wall of said grinding chamber (14) or grinding chambers (14), are arrayed substantially symmetrically about said grinding chamber (14) or grinding chambers (14) (generally horizontally or generally about the medial vertical axis (15) of said grinding chamber (14) or grinding chambers (14)), and are oriented to convey the pressurized carrier gas and the source material entrained therein to a plurality of grinding points (16). It should be apparent to one skilled in the art using the description herein and utilizing the present invention to its fullest extent that each said rotor (1) during rotation passes through a plurality of grinding points (16) and therefore a myriad of nozzle (17) arrays are practicable.

Furthermore, the method of the present invention is such that comminution of source material can be effected in embodiments utilizing any combination of one or a plurality of said rotors (1), one or a plurality of said grinding chambers (14), or one or a plurality of said nozzles (17), individually, collectively, concurrently, consecutively, sequentially, serially, or any combination thereof.

Said rotor (1) of the present invention is of a generally cylindrical shape. In its primary and preferred embodiment, said rotor (1) comprises two radial surfaces bounded by simple closed curves and a lateral periphery surface between and connecting said two radial surfaces. In a secondary embodiment, said rotor comprises two radial surfaces bounded by simple closed curves made up of discrete and distinct line segments and a plurality of lateral periphery surfaces between and connecting said two radial surfaces. In general, said secondary embodiment can be described as an equilateral or equiangular polygon. Hereinafter will be described the aforesaid primary and preferred embodiment of said rotor (1) and such description shall apply mutatis mutandis to the aforesaid secondary embodiment of said rotor (1).

Said rotor (1) may be solid or may be skeletonized to reduce moment. The aspect ratio of the thickness of said rotor (1) to the diameter of said rotor (1) can vary greatly and thus said rotor (1) can be described as any of a disk, a spoked wheel with rim (if skeletonized), a drum, or a cylinder. This aspect ratio shall be in the range of 0.001 to 20, more preferably in the range of 0.01 to 2, and most preferably at 0.105.

Generally, said rotor's (1) radial surfaces shall be parallel; however, and dependent on a multitude of factors, including the speed of rotation and the hardness and particulate size of the source material, said rotor's (1) radial surfaces may diverge or converge such that a portion of said rotor (1) has a greater thickness than other portions of said rotor (1). For example, a circular conical disc profile may occur when said rotor's (1) radial surfaces converge.

Said rotor (1) shall have a plurality of substantially equiangular and evenly spaced notches (2) along and generally transverse to the periphery of said rotor (1). The number of said notches (2) shall range from between 3 to 1,000, more preferably between 30 to 180, and most preferably at 45 notches. The circumferential spacing, being defined as the circumferential angle (5) between a medial radius (6) passing through a medial vertex (8) of a notch (2) and the radius (7) passing through the medial vertex (8) of the immediately adjacent notch (2), is the quotient of 360 divided by the number of said notches (2) along the periphery (3) of said rotor (1). Thus, the range and most preferable number for the circumferential spacing are the quotients calculated using the following formula: q=360/b, where b is the number of said notches (2) given in the aforementioned ranges and preferable number.

One variant of the aforesaid primary and preferred embodiment of said rotor (1) shall have no said notches (2); and therefore its lateral surface, which shall be without break or irregularity, shall act as a continuous impact surface.

The root diameter of each said notch (2), being defined as the distance along a medial radius (6) from the periphery (3) of said rotor (1) to the medial vertex (8) of a notch (2), shall be generally equal and shall be in the range of 0.5% and 50% of the diameter of said rotor (1), more preferably in the range of 2% and 33⅓%, and most preferably at 7% of the diameter of said rotor (1).

Each said notch (2) shall be of a generally v-shape and shall be comprised of an impact surface (11), being the first surface in the rotational direction, and a trailing surface (12); set, relative to each other, at a notch angle (9) in the range of 0.1° to 180°, more preferably 30° to 120°, and most preferably at 45°. However, and obviously, if said notch angle (9) is 180° then said notch (2) shall have a flat shape; and the primary and preferred embodiment and the secondary embodiment of said rotor (1) shall be coincident.

Said impact surface (11) shall be set to a medial angle (10), relative to a medial radius (6) passing through a medial vertex (8) of a notch (2), in the range of 45° backward-leaning to 120° backward-leaning, more preferably 35° backward-leaning to 50° backward-leaning, and most preferably at 42.3° backward-leaning.

Generally, said impact surfaces (11) and said trailing surfaces (12) shall be relatively flat; however, either or both may have different surface configurations. As examples, either or both may have a portion that has a greater radius relative to said rotor's (1) geometric centre than other portions of said surfaces; be generally concave or generally convex; or be textured, cambered, grooved, notched, or scalloped. Although not wanting to be limited by theory, it is believed that different surface configurations result in diverse airflows immediately about the periphery (3) of said rotor (1) and act to direct or substantially concentrate the stream of fluidized particles of source material into or about a following notch (2).

Each said impact surface (11) shall be comprised of either the bare material of said rotor (1) or a distinct and discrete generally abrasion and impact resistant material selected for use, in part, based upon the hardness, chemical composition, and reactivity of the source material. Preferred materials for said impact surfaces (11) are the material comprising said rotor (1); stainless steel; manganese steel; graphite; amorphous carbon; C₆₀; thick film diamond; high-density polymers; elastomeric materials; ceramics comprising metal compounds of oxides, borides, carbides, nitrides and mixtures thereof; or a composite of one or more of these materials; and the most preferred material is tungsten carbide. As well, said impact surfaces (11) may have coatings distinct from the principal material of said impact surfaces (11). For example, an elastomer such as neoprene may be used to increase rebound from the impact surface (11) or an adhesive may be used to increase surface adhesion thus allowing the source material to adhere to said impact surface (11) and thereby effect autogenous or semi-autogenous comminution.

If said impact surface (11) is of a material distinct and discrete from the bare material of said rotor, then each said impact surface (11) shall be placed within a said notch (2) such that each said impact surface (11) is generally equiangular relative to the radial surfaces of said rotor (1) as at its geometric centre. Each said impact surface (11) shall be mounted within a said notch (2) such that said impact surface (11) is physically held within said notch (2) either rigidly fixed in place or such that it is capable of movement such as oscillation about an angle of attack while the present invention is in operation. The means for mounting each said impact surface (11) is not especially critical and will depend upon materials of construction and the operating parameters of the present invention. Examples of methods for such mounting include adhesives, brazing, soldering, casting, clamping, and other means for mounting apparent to one skilled in the art using the preceding description and utilizing the present invention to its fullest extent.

In a secondary embodiment, each said notch (2) contains a root fitting secured to said rotor (1) by a fastening system known to one skilled in the art, including riveting, staking, spinning, hammering, pressing, peening, rolling, welding, upsetting, or coldheading, into which an external impact surface root assembly is attached by any of the several extant types of root attachments such as fir-tree, dovetail, or modified dovetail. For example, a notch (2) containing a fir-tree root fitting would have teeth on its leading surface (11) and its trailing surface (12) to match and join with an impact surface root assembly which would overall taper radially inwardly substantially in the shape of a wedge from the top (radially outside) to the bottom (radially inside).

Said rotor (1) shall be contained within said grinding chamber (14) of the present invention and shall be affixed therein by any of several means known to the art including said rotor (1) having a central aperture (4) which enables said rotor (1) to be placed and rotated upon a shaft (13) or said rotor (1) may be integral with said shaft (13) or said rotor (1) may be placed and rotated directly upon a drive motor's spindle. Any of a multitude of means known to the art may be used to drive said rotor (1) at variable speeds and in either a clockwise or counter-clockwise direction within said grinding chamber, and in the preferred embodiment a drive motor is used and operatively connected to said rotor (1). Similarly, any of a multitude of means known to the art may be used to attenuate or dampen any vibration resulting from such drive or rotation.

The axis of rotation of said rotor (1) may be at any angle relative to the medial vertical axis (15) of said grinding chamber (14); however, it is generally preferred that said rotor (1) be aligned generally vertically, or parallel to or upon said medial vertical axis (15), or generally horizontally, or transverse to said medial vertical axis (15).

Within said grinding chamber (14), said rotor (1) shall be oriented such that the approximate centre of each impact surface (11) intersects the grinding point (16), and the source material shall be introduced into said grinding chamber (14) such that the particulate source material is conveyed to said grinding point (16) at the intersection angle (20).

The means for projecting such particles of source material are known to the art and may include any of gravity feed, mechanical impulsion, electromagnetic impulsion, electrostatic impulsion, or entrainment within a fluid. Moreover, said means for projecting such particles of source material shall be capable of incremental velocity increase. In the preferred embodiment, such particles of source material are entrained within a carrier gas; such as compressed air, nitrogen, helium, or other noble gas, CO₂, steam (under pressure or superheated). Other vapours or gases may be selected for use primarily on the basis of compatibility with the source material provided that the source material involved is not degraded by contact with the carrier gas.

In an embodiment, the pressure within said grinding chamber (14) shall be at below atmospheric pressure. Although not wanting to be limited by theory, it is believed that a reduction from atmospheric pressure within said grinding chamber (14) will reduce the fluid density of the pressurized carrier gas and the source material entrained therein, thereby enabling greater source material velocity and thus increasing the efficacy of comminution.

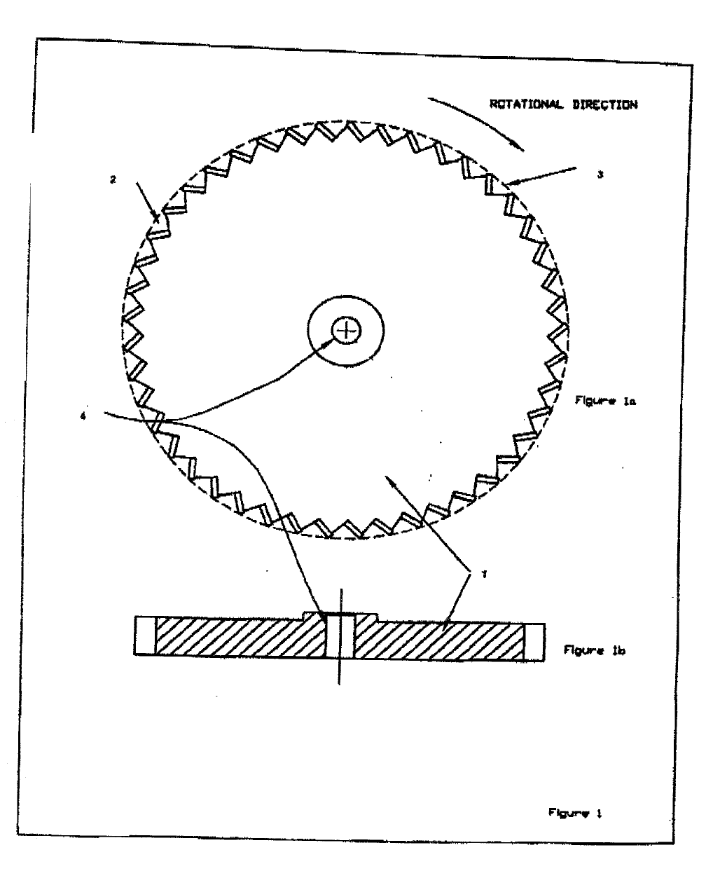

FIG. 1a shows the preferred embodiment of the rotor of the present invention. As illustrated, said rotor (1) may be described as a disk comprised of two parallel radial surfaces and a lateral periphery surface and having an aspect ratio of 0.105. As can be seen, there are 45 equiangular notches (2) spaced every 8° along and transverse to the periphery (3) of said rotor (1) within which 45 impact surfaces (11) are contained. The root diameter of each said notch (2) is 7% of the diameter of said rotor (1).

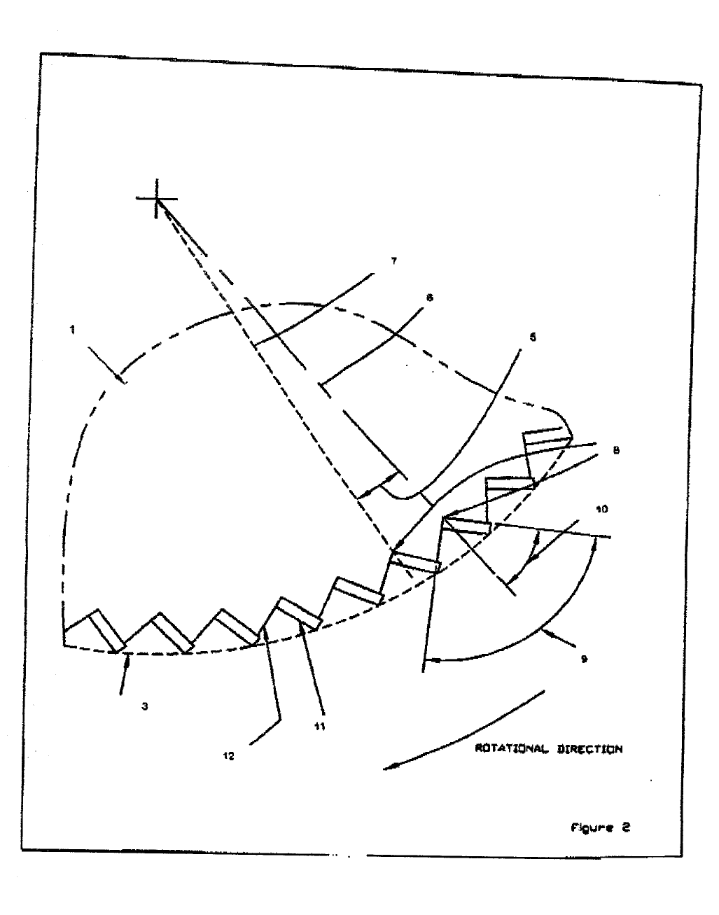

As can be seen in FIG. 2, in the preferred embodiment each said notch (2) is of a generally v-shape and is comprised of a leading surface (11) and a trailing surface (12) set at a 90° notch angle (9) relative to each other. As can be further seen in FIG. 2 each said impact surface (11) is a relatively flat, solid surface set at a 42.3° backward-leaning medial angle (10) relative to the medial radius (6) passing through the medial vertex (8) of a notch (2). In the preferred embodiment, each said impact surface (11) is by means of brazing rigidly fixed in place perpendicular to either radial surface of said rotor (1).

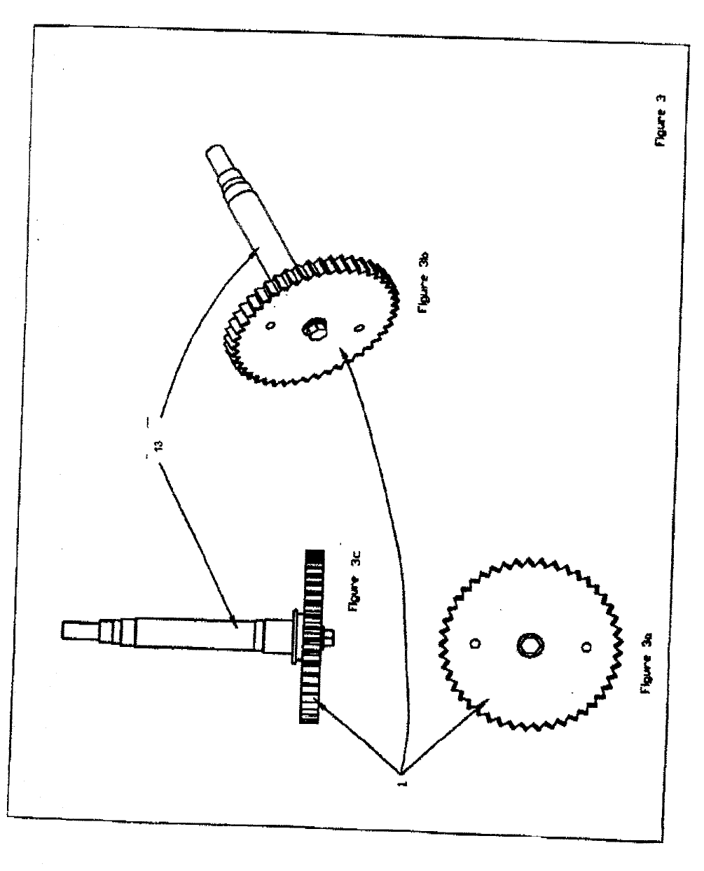

FIG. 3a shows said rotor's (1) central aperture (4), and FIGS. 3b and 3c shows said rotor (1) mounted upon said shaft (13).

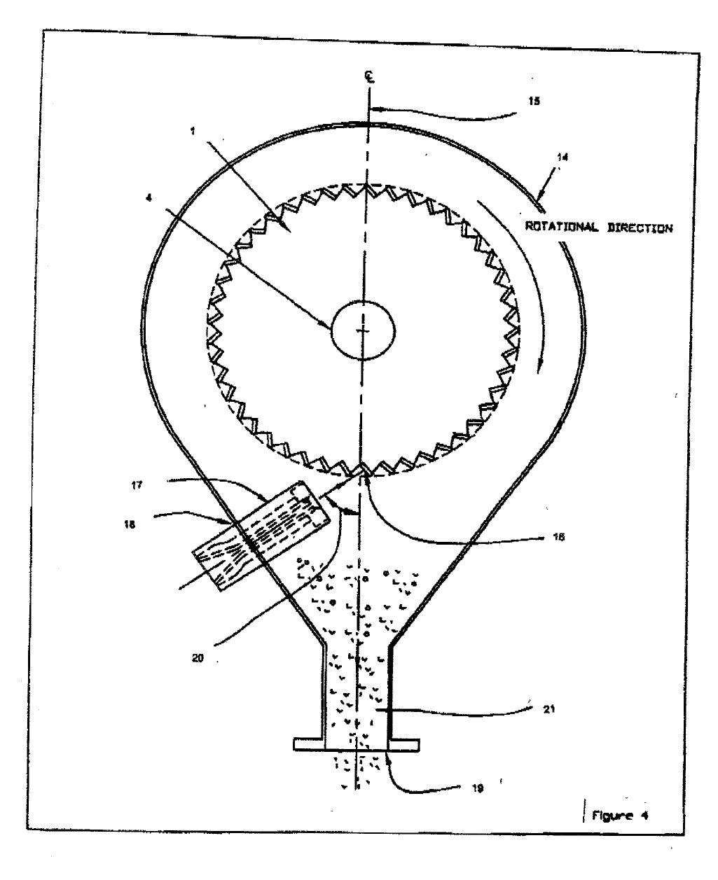

As can be seen in FIG. 4, in the preferred embodiment, said rotor (1) is oriented within said grinding chamber (14), which is roughly of an inverted teardrop shape, such that said rotor (1) rotates in a clockwise direction vertically and upon said grinding chamber's (14) medial vertical axis (15).

Moreover, FIG. 4 illustrates the process of comminution in the preferred embodiment: said rotor (1) is rotated and fluidized particulate source material is introduced into said grinding chamber (14) such that the fluidized stream of particulated source material impacts the approximate centres of said impact surfaces (11) at said grinding point (16) and the source material entrained within the fluidized stream is comminuted. The comminuted particles and the uncomminuted particulate source material (22) then fall generally downward in said grinding chamber (14) and are removed through the exit aperture (19) at the bottom of said grinding chamber (14).

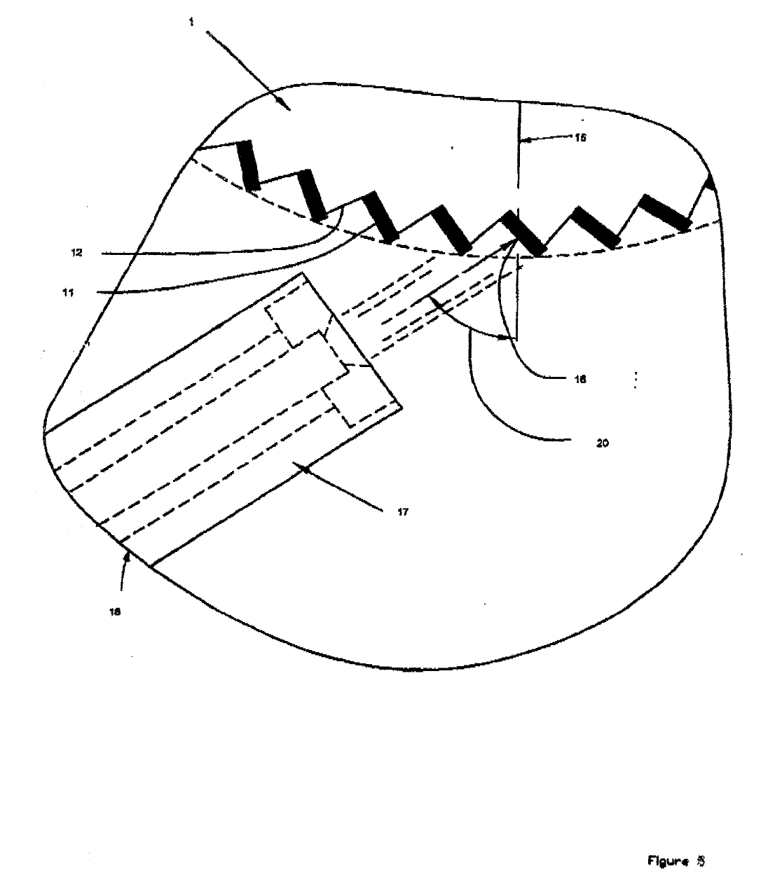

FIG. 5 shows a nozzle aperture (18) through which one said nozzle (17) is mounted upon the peripheral wall of one said grinding chamber (14). The fluidized particulate source material is accelerated within said nozzle (17), which is aligned such that the fluidized particulate source material exiting said nozzle (17) intersects the medial vertical axis (15) of said grinding chamber (14) at said grinding point (16) at a 55° intersection angle (20).

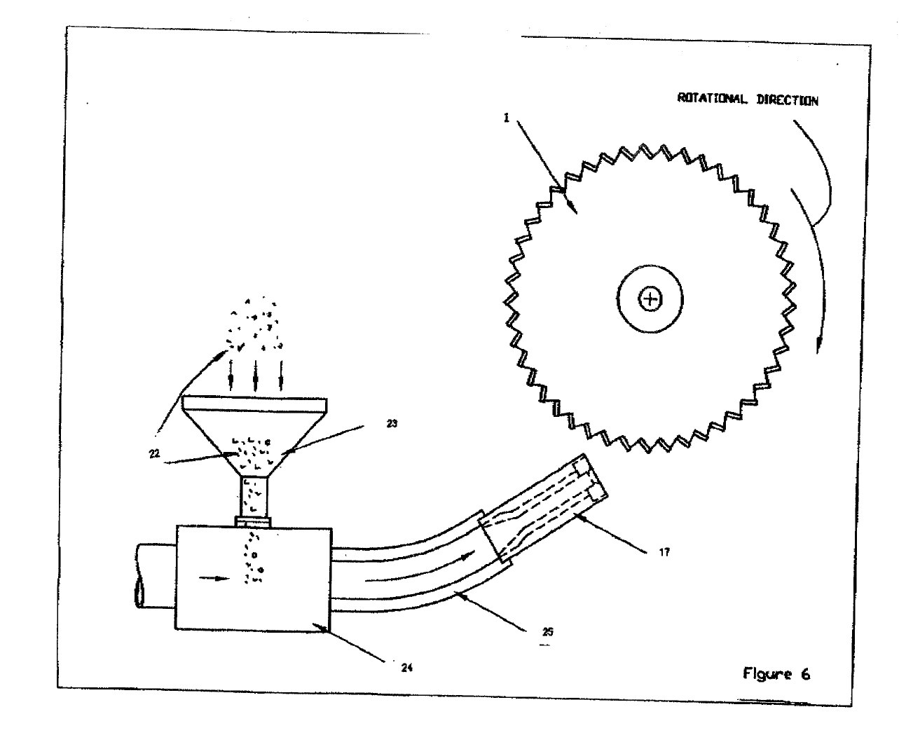

FIG. 6 shows an embodiment in which the particulate source material (22) is delivered into a hopper (23) that sits atop and feeds into an air mixture chamber (24). Compressed air—which acts as the pressurized carrier gas—is introduced into said air mixture chamber (24) to fluidize the particulate source material and to thereafter impel the fluidized and entrained particulate source material into and through a conduit (25) and into and through one said nozzle (17).

The described embodiments are to be considered in all respects only as illustrative and not restrictive. It is to be understood that the terminology used is intended to be in the nature of words of description rather than of limitation and that lists of preferences, variants, or alternatives are illustrative and not exhaustive whether or not words such as or similar to “but not limited to” or “for example” are used herein. Many modifications and variations of the present invention are possible in light of the teachings herein; and, therefore, the scope of the present invention is indicated by the appended claims rather than by the foregoing description. All changes that come within the meaning and range of equivalency of the claims are to be embraced within their scope.

The embodiments of the invention in which an exclusive property or privilege is claimed are defined as follows:

1. A comminuting device for comminuting materials comprising:
(a) a grinding chamber;
(b) a drive motor mounted in operative relation to said grinding chamber;
(c) an impact rotor operatively connected to said drive motor, said rotor comprising two radial surfaces and a lateral periphery surface between and connecting said two radial surfaces, and having a plurality of notches along and generally transverse to its periphery, and having within each said notch an impact surface and a trailing surface set at an angle in a range of 0.1° to 180° to each other, and either or both each said impact surface and each said trailing surface being generally flat, generally concave, or generally convex, or textured, cambered, grooved, notched, or scalloped, and being generally concentrically mounted within said grinding chamber for rotation about an axis and its geometric centre such that said impact surface is the leading surface of rotation;
(d) a nozzle fitted into said grinding chamber and adapted to feed and target particles of source material into the interior of said grinding chamber such that said particles of source material collide with said plurality of impact surfaces located on said rotating impact rotor as said impact surfaces pass through a grinding point; and
(e) an exit aperture disposed along said grinding chamber and adapted to discharge comminuted particles from said grinding chamber.

2. The impact rotor as defined in claim 1 having within each said notch a root fitting means of attaching an impact surface.

3. The impact rotor as defined in claim 1 comprising two radial surfaces bounded by simple closed curves made up of discrete and distinct line segments and a plurality of lateral periphery surfaces between and connecting said two radial surfaces and having upon said lateral periphery surfaces a plurality of impact surfaces.

4. The impact rotor as defined in claim 3 wherein each said peripheral surface is generally flat; or has a portion that has a greater radius relative to said rotor's geometric centre than other portions of said peripheral surface; or is generally concave or generally convex; or is textured, cambered, grooved, notched, or scalloped.

5. The impact rotor as defined in claim 1 wherein said impact surface is comprised of the same material as said impact rotor.

6. The impact rotor as defined in claim 1 wherein the material comprising said impact surface is comprised of an abrasion and impact resistant material selected from the group consisting of stainless steel; manganese steel; tungsten carbide; graphite; amorphous carbon; C₆₀; thick film diamond; high-density polymers; elastomeric materials; ceramics comprising metal compounds of oxides, borides, carbides, nitrides and mixtures thereof; or a composite of one or more of these materials.

7. The impact rotor as defined in claim 1 wherein said impact surfaces have coatings distinct from the principal material of said impact surfaces.

8. The impact rotor as defined in claim 1 wherein said impact surfaces are rigidly fixed in place within said notches to prevent undesired disengagement of said impact surfaces from said impact rotor.

9. A method of comminuting particles of material by colliding said particles against a rotating impact device as defined in claim 1.

10. The comminution method as defined in claim 9 wherein particles of material are collided against a plurality of said impact devices contained within a single said grinding chamber.

11. The comminution method as defined in claim 9 wherein particles of material are collided against a plurality of said impact devices contained within a plurality of said grinding chambers.

12. The comminution method as defined in claim 10 wherein said impact targets are impacted individually, collectively, concurrently, consecutively, sequentially, serially, or any combination thereof.

13. The comminution method as defined in claim 11 wherein said impact targets are impacted individually, collectively, concurrently, consecutively, sequentially, serially, or any combination thereof.

14. The comminution method as defined in claim 10 wherein particles of material are collided against said impact device by means of mechanical impulsion, gravity feed, electromagnetic impulsion, or electrostatic impulsion.

15. The comminution method as defined in claim 10 wherein particles of material are collided against said impact device by means of fluidizing said particles within a gaseous stream and thereafter projecting said particles through at least one said nozzle.

16. The comminution method as defined in claim 10 wherein particles of material are collided against said impact device by means of fluidizing said particles within a gaseous stream and thereafter projecting said particles through a plurality of said nozzles.
